(19) United States
(12) Patent Application Publication
(10) Pub. No.: US 2014/0304113 A1
(43) Pub. Date: Oct. 9, 2014

(54) SYSTEM AND METHOD FOR SCORING ONE OR MORE RESIDENTIAL APPRAISERS

(71) Applicant: Robert E. Henger, Birmingham, AL (US)

(72) Inventor: Robert E. Henger, Birmingham, AL (US)

(21) Appl. No.: 14/247,180

(22) Filed: Apr. 7, 2014

Related U.S. Application Data
(60) Provisional application No. 61/809,395, filed on Apr. 7, 2013.

(51) Int. Cl. G06Q 30/06

(52) U.S. Cl. CPC G06Q 30/0609
USPC 705/26.35

(57) ABSTRACT

A system and method for scoring one or more residential appraisers includes a server system and a software module. The software module provides a score in the range of 300 to 800 and includes the one or more residential appraisers' license revocation information, suspension information, one or more verifiable negative source lists information, one or more legal public records information, a selected one of one or more MARI questions and one or more occurrences information, negative online information, a plurality of E and O information, a number of years of experience, a plurality of license and accreditation information and being on a top 25 lenders list information.

This application claims priority to U.S. Provisional Application 61/809,395 filed on Apr. 7, 2013, the entire disclosure of which is incorporated by reference.

### BACKGROUND OF THE INVENTION

1. Field of the Invention

The present invention is a system and method. More specifically, the present invention is a system and method for scoring one or more residential appraisers.

2. Description of the Related Art

In the aftermath of the economic housing crisis and implementation of the Dodd Frank Act, regulators, bankers, lenders, credit unions and appraisal management companies are seeking a universal system to measure the quality and experience of an appraiser that may be assigned to value the collateral of a mortgage loan. Unfortunately, many of these entities do not have qualified employees to evaluate the quality of an individual appraisers' work.

The present invention provides a system and method for scoring one or more residential appraisers with a universal model which a lender can use to make inclusion or exclusion decisions regarding which appraisers they hire for collateral valuation assignments. The system and method for scoring one or more residential appraisers is similar to a Fair Isaac Company or FICO credit scoring system utilized by credit bureaus.

### BRIEF SUMMARY OF THE INVENTION

The present invention is a system and method. More specifically, the present invention is a system and method for scoring one or more residential appraisers.

The system and method for scoring one or more residential appraisers is a basis upon which a lender can include or exclude an individual from being on an institution's approved list of appraisers. The system and method for scoring one or more residential appraisers is an industry accepted scoring system that can assist an appraiser in a goal toward higher performance that also provides regulators a measurable yard stick for corrective action. The system and method for scoring one or more residential appraisers is an unbiased, uniform and industry accepted scoring system that can assist in any efforts towards a national license or a national registration process should it begin to gain regulatory momentum and be implemented.

The system and method for scoring one or more residential appraisers includes a server system and a software module. The system for scoring one or more residential appraisers includes a server system with an output system, an input system, a memory system, a processor system and a communications system and a software module residing on the memory system, the software module provides a score in the range of 300 to 800 and includes the one or more residential appraisers' license revocation information, the one or more residential appraisers' license suspension information, the one or more residential appraisers' one or more verifiable negative source lists information, the one or more residential appraisers' one or more legal public records information, the one or more residential appraisers' selected one of one or more MARI questions and one or more occurrences information, the one or more residential appraisers' negative online information, the one or more residential appraisers' plurality of E and O information, the one or more residential appraisers' number of years of experience, the one or more residential appraisers' plurality of license and accreditation information and the one or more residential appraisers' being on a top 25 lenders' list information.

It is an object of the present invention to provide a system for scoring one or more residential appraisers.

It is an object of the present invention to provide a method for scoring one or more residential appraisers.

It is an object of the present invention to provide a software module for scoring one or more residential appraisers.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a block diagram of a system for scoring one or more residential appraisers, in accordance with one embodiment of the present invention.

FIG. 2 illustrates a block diagram of a server system, in accordance with one embodiment of the present invention.

FIG. 3 illustrates a diagram of a software module for scoring one or more residential appraisers, in accordance with one embodiment of the present invention.

FIG. 4 illustrates a flowchart of a method for scoring one or more residential appraisers, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

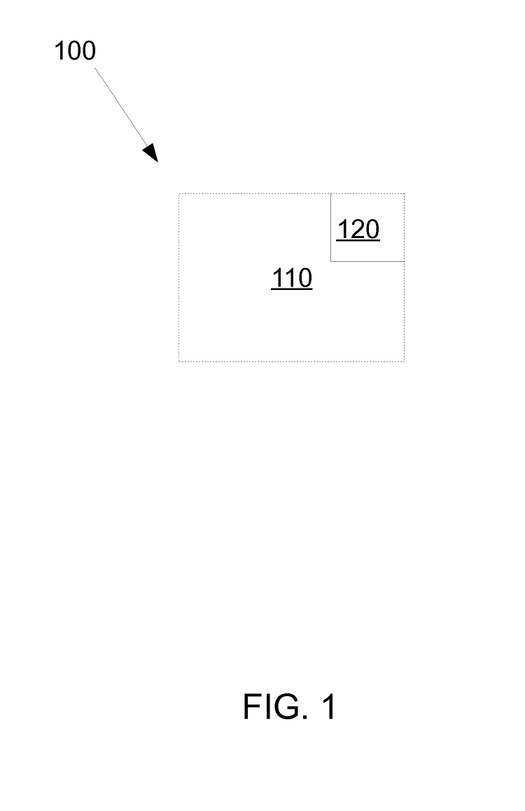

FIG. 1 illustrates a block diagram of a system 100 for scoring one or more residential appraisers, in accordance with one embodiment of the present invention.

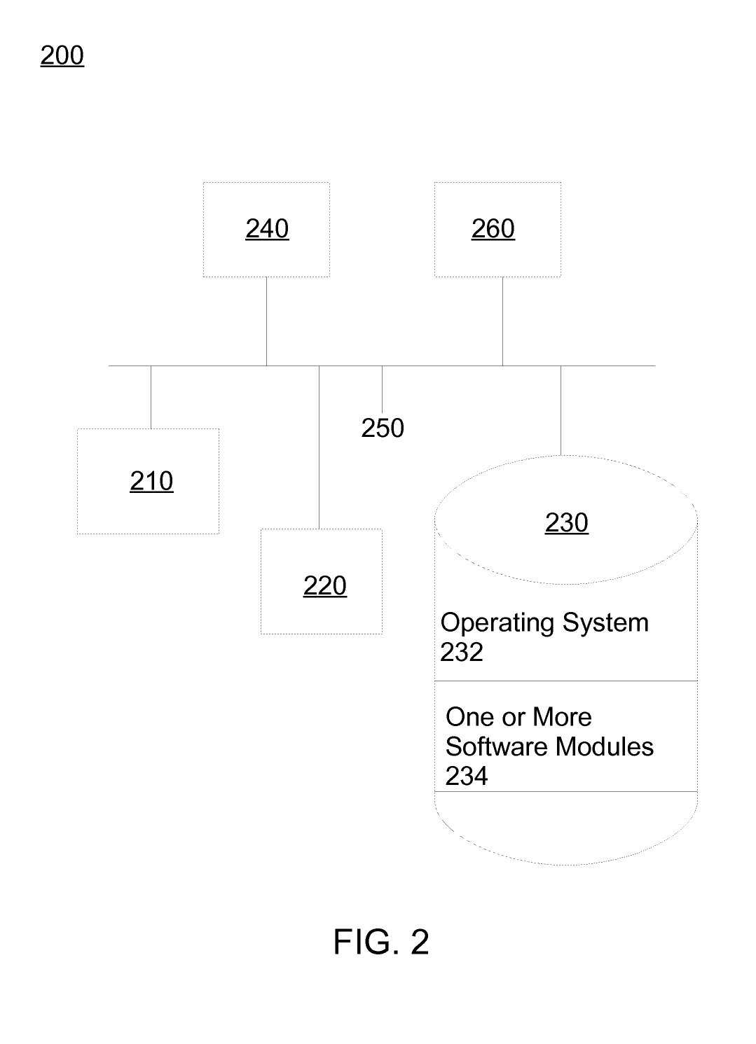

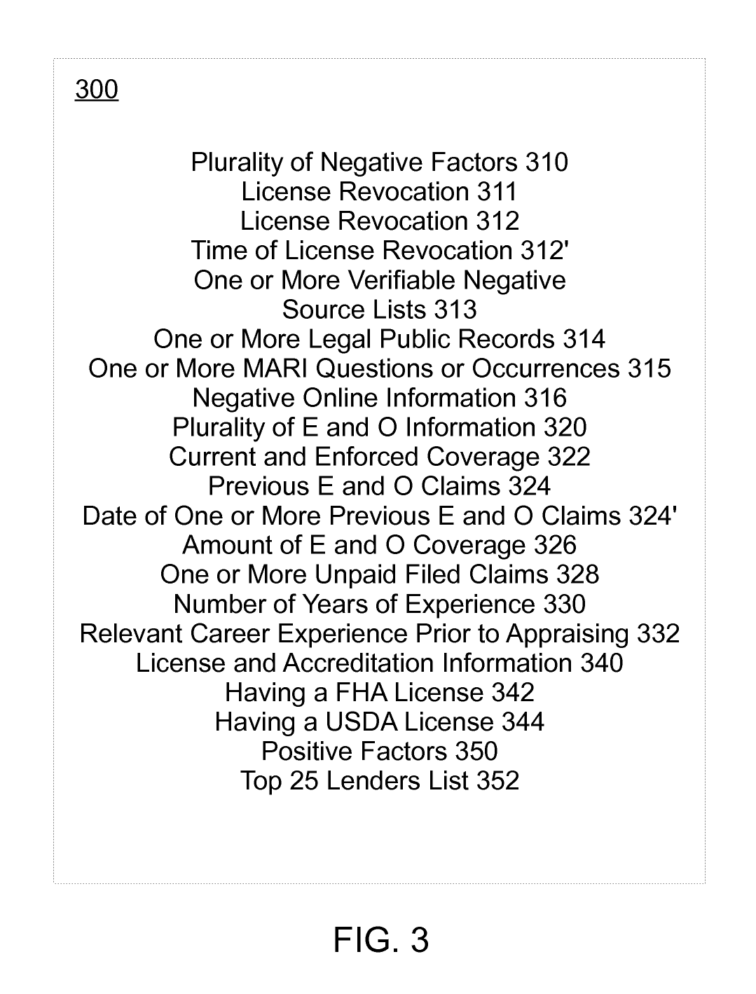

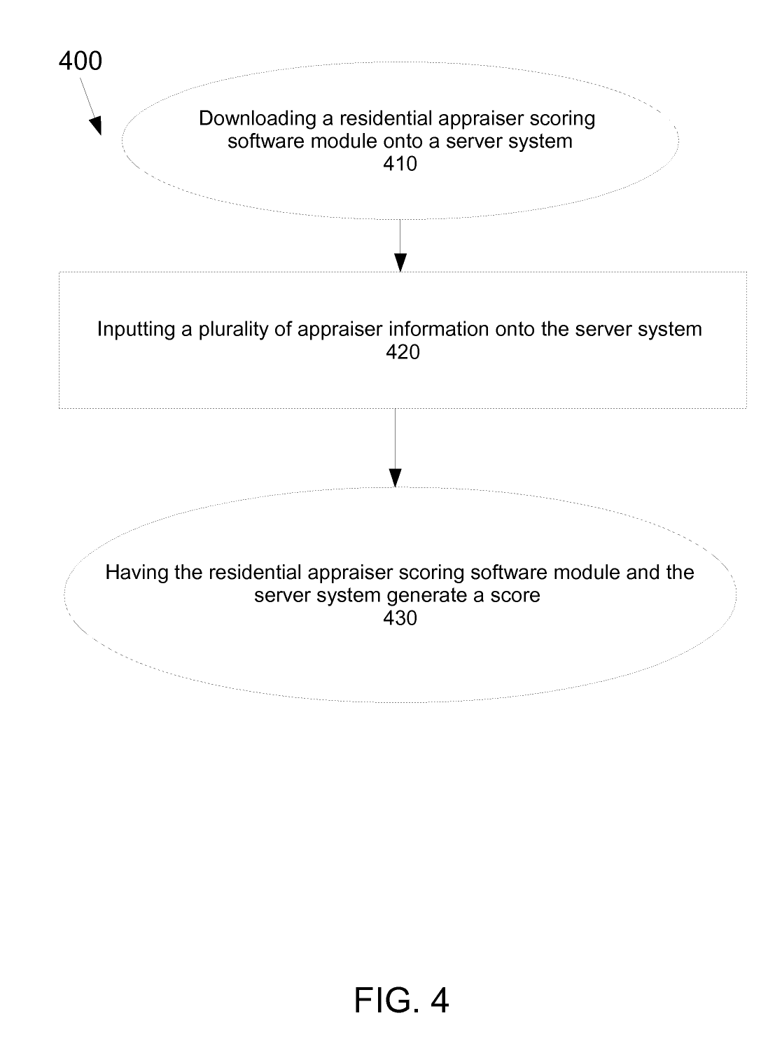

The system 100 includes a server system 110 and a software module 120. The server system 110 may have one or more servers and may include additional components and/or may not include all of the components listed above. Additional details regarding the server system 110 are described in FIG. 2. The software module 120 resides on the server system 110 and contains a plurality of data and a plurality of instructions to perform the method for scoring one or more residential appraisers (FIG. 4, 400). Additional details regarding the software module 120 are described in FIG. 3.

FIG. 2 illustrates a block diagram of a server system 200, in accordance with one embodiment of the present invention.

The server system 200 may include an output system 210, an input system 220, a memory system 230, a processor system 240, a communications system 250 and an input and output system 260. The server system 200 may include additional components and/or may not include all of the components listed above. The server system 200 is a similar server system 110 illustrated and described in FIG. 1 and its description.

The output system 210 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

The input system 220 may include any one of, some of, any combination of, or all of a keyboard system, a mouse system, a track ball system, a track pad system, one or more buttons on a handheld system, a scanner system, a microphone system, a connection to a sound system, and/or a connection and/or interface system to a computer system, intranet, and/or Internet (e.g., IrDA, USB), for example.

The memory system 230 may include, for example, any one of, some of, any combination of, or all of a long term storage system, such as a hard drive; a short term storage system, such as random access memory; a removable storage system, such as a floppy drive or a removable drive and/or flash memory. Memory system 230 may include one or more machine-readable mediums that may store a variety of different types of information. The term machine-readable medium is used to refer to any medium capable of carrying information that is readable by a machine. One example of a machine-readable medium is a computer-readable medium. Memory system 230 may store one or more machine instructions for scoring one or more residential appraisers.

The memory system 230 may also include an operating system 232 and one or more software modules 234. The one or more software modules 234 reside on the memory system 230 and provide instructions to perform a method for scoring one or more residential appraisers (FIG. 3, 300). Additional details regarding the one or more software modules 234 are illustrated and described in FIG. 3 and its description.

The processor system 240 may include any one of, some of, any combination of, or all of multiple parallel processors, a single processor, a system of processors having one or more central processors and/or one or more specialized processors dedicated to specific tasks. Processor system 240 may include one or more digital signal processors or DSPs in addition to or in place of one or more central processing units or CPUs and/or may have one or more digital signal processing programs that run on one or more CPU. Processor system 240 may implement the machine instructions stored in memory system 230.

The communications system 250 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input and output system 260 may include devices that have the dual function as input and output devices. For example, input and output system 260 may include one or more touch sensitive screens, which display an image and therefore are an output device and accept input when the screens are pressed by a finger or a stylus, for example. The touch sensitive screens may be sensitive to heat and/or pressure. One or more of the input and output devices may be sensitive to voltage or current produced by a stylus for example. Input and output system 260 is optional and may be used in addition to or in place of output system 210 and/or input device 220.

In one embodiment of the present invention, a system for scoring one or more residential appraisers is provided.

In one embodiment of the present invention, a method for scoring one or more residential appraisers is provided.

In one embodiment of the present invention, a software module for scoring one or more residential appraisers is provided.

FIG. 3 illustrates a software module 300 for scoring one or more residential appraisers, in accordance with one embodiment of the present invention.

The software module 300 includes a plurality of negative factors 310, a plurality of errors and omissions insurance or E and O information 320, a number of years of experience information 330, a plurality of license and accreditation information 340 and a plurality of positive factors 350. The negative factors 310 include license revocation information 311, license suspension information 312, one or more verifiable negative source lists information 313, one or more legal public records information 314, one or more Mortgage Asset Research Institute, Inc. or MARI questions or occurrences information 315 and negative online information 316. The license revocation information 311 defaults to a score of 300 automatically if an appraisers' license is revoked. The license suspension information 312 includes time since reinstatement 312′. The time since reinstatement 312′ can be in the range of 0 months to 6 months, 6 months to 1 year, 1 year to 2 years, 2 years to 5 years or 5 years to 10 years. Any currently suspended license defaults to a score of 300 automatically. The verifiable negative source lists information 313 is from the Federal Housing Administration or FHA, the Veterans Administration or VA, the United States Department of Agriculture or USDA and other top mortgage lenders lists. Additionally, historical suspensions are reinstated if possible. The E and O information 320 includes current and enforced coverage 322, one or more previous E and O claims 324, an amount of E and O coverage 326 and one or more unpaid filed claims 328. The one or more previous E and O claims 324 includes the date of the one or more previous E and O claims 324′. Any previous E and O claims 324 paid within the range of 0 years to 5 years, 5 years to 10 years and over 10 years are reviewed. The number of years of experience 330 includes relevant career experience prior to appraising 332. The number of years of experience 330 includes ranges from 0 years to 2 years, 2 years to 5 years, 5 years to 10 years, 10 years to 20 years and 20 years to 30 years. The relevant career experience prior to appraising 332 must also be provided. Appraisers with more than 30 years of experience will begin to have a decreasing score. The license and accreditation information 340 includes having a FHA license 342 or having a USDA license 344. The length of time having a FHA license 342 or having a USDA license 344 is in the range of 0 years to 5 years, 5 years to 10 years and over 10 years. The positive factors 350 include being on a top 25 lenders list 352. The top 25 lenders list 352 includes major banks and selective midsized banks such as Chase, Citi, Bank of America, PNC, US Bank, SunTrust, FAMC, Sterns, Flagstar, Alley or BB & T.

The software module 300 provides a score in the range of 300 to 800, which is similar, but not the same as a FICO score. An appraiser that has all of the positive factors at the highest level of priority and has zero negative factors will score 800. The probability of an 800 score will likely be less than approximately 1% of all appraisers. An appraiser that has most of the positive factors at various sublevels will score in the range of 700 to 780. An appraiser that has most of the positive factors at various sub-levels and has a small historical issue or item on the negative factor variables will typically score in the range of 680 to 760. An appraiser that has some of the positive factors at various sub-levels and has several historical or open negative factors will score likely in the range of 600 to 700. An appraiser that has a few positive factors and several open negative factors will likely score in the range of 580 to 660. An appraiser that has a few positive factors and is listed on several exclusion lists, is in litigation but is not suspended or has a license revoked will likely score in the range of 450-580. An appraiser that is under suspension from his appraiser's license will have a score of 350 and an appraiser that presently has a revoked appraiser's license will have score of 300. If the software module is unable to confirm or verify substantial facts that will have career implications on an appraiser, then a N/A will be issued.

FIG. 4 illustrates a flowchart of a method 400 for scoring one or more residential appraisers, in accordance with one embodiment of the present invention.

The method 400 steps include downloading a residential appraiser scoring software module onto a server system 410, inputting a plurality of appraiser information onto the server system 420 and having the residential appraiser scoring software module and the server system generate a score 430.

The downloading a residential appraiser scoring software module onto a server system step 410 is from a selected one of a CD ROM and over the Internet or other suitable downloading method. The server system includes an output system, an input system, a memory system, a processor system, a communications system and an input and output system. The appraiser information includes a plurality of negative factors, a plurality of errors and omissions insurance or E and O information, a number of years of experience, a plurality of license and accreditation information and a plurality of positive factors. The negative factors include license revocation, license suspension, being on one or more verifiable negative source lists, having one or more legal public records, having a Mortgage Asset Research Institute, Inc. or MARI question or occurrence and having negative online information. The positive factors include being on a top 25 lenders list. The generated score is in the range of 300 to 800 and indicates a quality level of performance achieved by the appraiser. The higher the score within the range of 300 to 800, the higher the quality of the appraiser. The inputting a plurality of appraiser information onto the server system 420 includes inputting the appraiser information with an input system, downloading the appraiser information from another server system over a communications network or downloading the appraiser information from a CD ROM disc or other suitable media. The having the residential appraiser scoring software module and the server system generate a score 430 is performed by the processing system that is in communication with the memory system and software module.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A system for scoring one or more residential appraisers, comprising:
a server system with an output system, an input system, a memory system, a processor system and a communications system; and
a software module residing on the memory system, the software module provides a score in the range of 300 to 800 and includes one or more residential appraisers' license revocation information, one or more residential appraisers' license suspension information, one or more residential appraisers' one or more verifiable negative source lists information, one or more residential appraisers' one or more legal public records information, one or more residential appraisers' selected one of one or more MARI questions and one or more occurrences information, one or more residential appraisers' negative online information, one or more residential appraisers' plurality of E and O information, one or more residential appraisers' number of years of experience, one or more residential appraisers' plurality of license and accreditation information and one or more residential appraisers' being on a top 25 lenders list information.

2. The system according to claim 1, wherein the one or more residential appraisers defaults to a score of 300 automatically if the one or more residential appraisers' license is revoked.

3. The system according to claim 1, wherein the verifiable negative source lists information is from the FHA, the VA and the USDA.

4. The system according to claim 1, wherein the one or more residential appraisers' E and O information includes current and enforced coverage, one or more previous E and O claims, an amount of E and O coverage and one or more unpaid filed claims.

5. The system according to claim 1, further comprising one or more residential appraisers' relevant career experience prior to appraising is provided.

6. The system according to claim 1, wherein the one or more residential appraisers with more than 30 years of experience will begin to have a decreasing score.

7. The system according to claim 1, wherein the license and accreditation information includes having a selected one of a FHA license and a USDA license.

8. A system for scoring one or more residential appraisers, comprising:
a server system with an output system, an input system, a memory system, a processor system, a communications system and an input and output system; and
a software module residing on the memory system, the software module provides a score in the range of 300 to 800 and includes the one or more residential appraisers' license revocation information, one or more residential appraisers' license suspension information, one or more residential appraisers' one or more verifiable negative source lists information, one or more residential appraisers' one or more legal public records information, one or more residential appraisers' selected one of one or more MARI questions and one or more occurrences information, one or more residential appraisers' negative online information, one or more residential appraisers' plurality of E and O information, one or more residential appraisers' number of years of experience, one or more residential appraisers' plurality of license and accreditation information and one or more residential appraisers' being on a top 25 lenders list information.

9. The system according to claim 8, wherein the one or more residential appraisers defaults to a score of 300 automatically if the one or more residential appraisers' license is revoked.

10. The system according to claim 8, wherein the verifiable negative source lists information is from the FHA, the VA and the USDA.

11. The system according to claim 8, wherein the one or more residential appraisers' E and O information includes current and enforced coverage, one or more previous E and O claims, an amount of E and O coverage and one or more unpaid filed claims.

12. The system according to claim 8, further comprising one or more residential appraisers' relevant career experience prior to appraising is provided.

13. The system according to claim 8, wherein the one or more residential appraisers with more than 30 years of experience will begin to have a decreasing score.

14. The system according to claim 8, wherein the license and accreditation information includes having a selected one of a FHA license and a USDA license.

15. The system according to claim 8, further comprising a probability of an 800 score is less than 1% of the one or more residential appraisers.

16. A method for scoring one or more residential appraisers, comprising:
downloading a residential appraiser scoring software module onto a server system;
inputting a plurality of residential appraiser information onto the server system; and
having the residential appraiser scoring software module and the server system generate a score.

17. The method according to claim 16, wherein downloading is from a CD ROM.

18. The method according to claim 16, wherein the residential appraiser scoring software module provides the score in the range of 300 to 800.

19. The method according to claim 18, wherein the score indicates a quality level of performance achieved by the appraiser.

20. The method according to claim 16, wherein the input residential appraiser information includes one or more residential appraisers' license suspension information, one or more residential appraisers' one or more verifiable negative source lists information, one or more residential appraisers' one or more legal public records information, one or more residential appraisers' selected one of one or more MARI questions and one or more occurrences information, one or more residential appraisers' negative online information, one or more residential appraisers' plurality of E and O information, one or more residential appraisers' number of years of experience, one or more residential appraisers' plurality of license and accreditation information and one or more residential appraisers' being on a top 25 lenders list information.
